(19) United States
(12) Patent Application Publication
(10) Pub. No.: US 2002/0122028 A1
(43) Pub. Date: Sep. 5, 2002

(54) External keyboard for PDAs

(76) Inventor: Sen-Cheng Wang, Taipei Hsien (TW)

Correspondence Address: BIRCH STEWART KOLASCH & BIRCH, PO BOX 747, FALLS CHURCH, VA, 22040-0747, US

(21) Appl. No.: 09/797,707

(22) Filed: Mar. 5, 2001

(51) Int. Cl. G09G 5/00

(52) U.S. Cl. 345/168

(57) ABSTRACT

An external keyboard for PDAs includes first and second sections hinged together. The keyboard is adapted for electrically connected with a PDA (Personal Digital Assistant) device and then serving as an inputting device for the connected PDA. A PDA device supporting bracket is built-in the keyboard for easy install a PDA device thereon for easy operation of the PDA. The supporting bracket further includes an anchoring leg such that the supporting bracket can be firmly positioned in an inclined position. Accordingly, a screen of the PDA device can be easily read. The PDA supporting bracket can be readily stored within the keyboard when the first and second sections are folded together.

### FIELD OF THE INVENTION

The present invention relates to a keyboard, and more particularly to a keyboard, and more particularly to a keyboard having first and second sections hinged together. The keyboard is adapted for electrically connected with a PDA (Personal Digital Assistant) and then serving as an inputting device for the connected PDA. A PDA device supporting bracket is built-in the keyboard for easy install a PDA device thereon for easy operation of the PDA. The PDA supporting bracket can be readily stored within the keyboard when the first and second sections are folded together.

### DESCRIPTION OF THE PRIOR ART

As shown in FIG. 5, a PDA device can be easily pocketed, while it is not provided with a keyboard in light of its compact dimension and size. In order to provide a quick input of the data, an external keyboard is therefore interconnected thereto for quick data entry if required.

The existing keyboard is very much similar to the existing keyboard in which each keyswitch is generally mounted on the same supporting bracket. In brief, the existing keyboard has a fixed dimension which cannot be changed. Even the size of the keyboard can be made as small as an electronic dictionary, it cannot be folded to reduce its overall size. As shown in FIG. 5, the conventional keyboard generally includes a housing (a) in which a plurality of keyswitches (b) are mounted. The keyboard is provided with a connector (c) adapted to be electrically connected to a PDA device (d). By this arrangement, the user can quickly make data entry by means of the keyswitches (b) when the PDA device (d) is connected to the keyboard (a).

Apparently, the dimension of the PDA device (d) is comparably larger than the connected PDA device (d) because each keyswitch (b) has to have a robust space with adjacent keyswitches (b) to provide enough room for fingers. Accordingly, it is unlikely to carry the keyboard together with the PDA device (d). If the keyboard is made for portable, apparently, the keyswitches will be stuck together such that it will be very difficult for the user to make data entry. Most important, the PDA device (d) has to be firmly supported and connected during data entry. However, the conventional keyboard can only provide an electrical connection, while the PDA device (d) cannot be firmly supported. When the PDA device (d) lies on the table, it will be difficult for the user to read the input data.

### SUMMARY OF THE INVENTION

It is an objective of this invention to provide a keyboard device in which the keyboard includes first and second sections hinged together thereby reducing the overall dimension of the keyboard. Consequently, the keyboard with reduced size can be easily pocketed with a PDA device.

It is still an objective of this invention to provide a keyboard device in which a PDA device supporting bracket is built-in one of the section and the supporting bracket can be easily pulled out for supporting the PDA device thereon, while can be also easily flattened when first and second sections are folded together.

In order to achieve the objective set forth, an external keyboard for PDAs in accordance with the present invention includes first and second sections hinged together. The keyboard is adapted for electrically connected with a PDA (Personal Digital Assistant) device and then serving as an inputting device for the connected PDA. A PDA device supporting bracket is built-in the keyboard for easy install a PDA device thereon for easy operation of the PDA. The supporting bracket further includes an anchoring leg such that the supporting bracket can be firmly positioned in an inclined position. Accordingly, a screen of the PDA device can be easily read. The PDA supporting bracket can be readily stored within the keyboard when the first and second sections are folded together.

### BRIEF DESCRIPTION OF THE DRAWINGS

FIG. 1 is an exploded perspective view of an external keyboard for PDAs in accordance with the present invention;

FIG. 2 is an illustration in which first and second keyboard subassemblies are unfolded;

FIG. 3 is an illustration in which a supporting bracket is firmly supported by an anchoring foot and on which a PDA device is mounted thereon;

FIG. 4 is an illustration in which first and second keyboard subassemblies are folded together; and

FIG. 5 is an illustration of a conventional keyboard in which a PDA device is electrically connected.

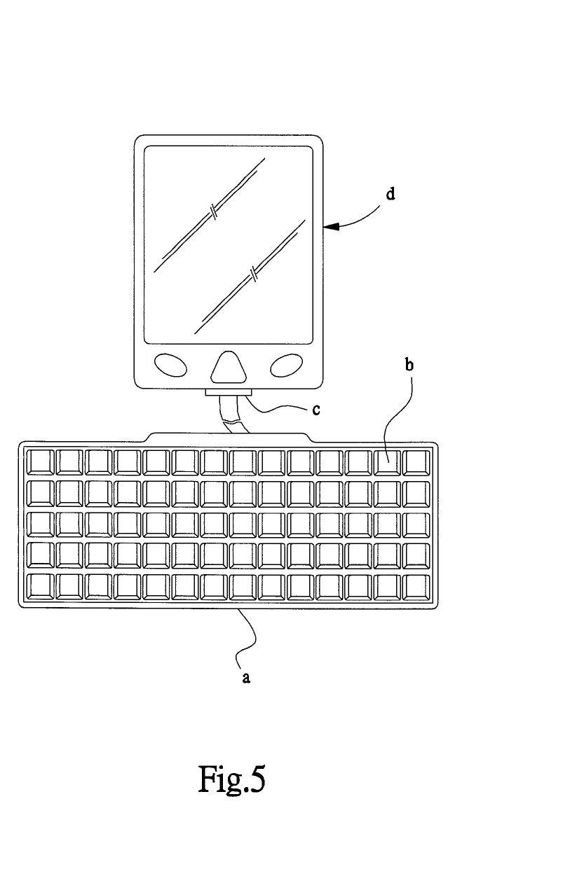

### DETAILED DESCRIPTION OF THE PREFERRED EMBODIMENT

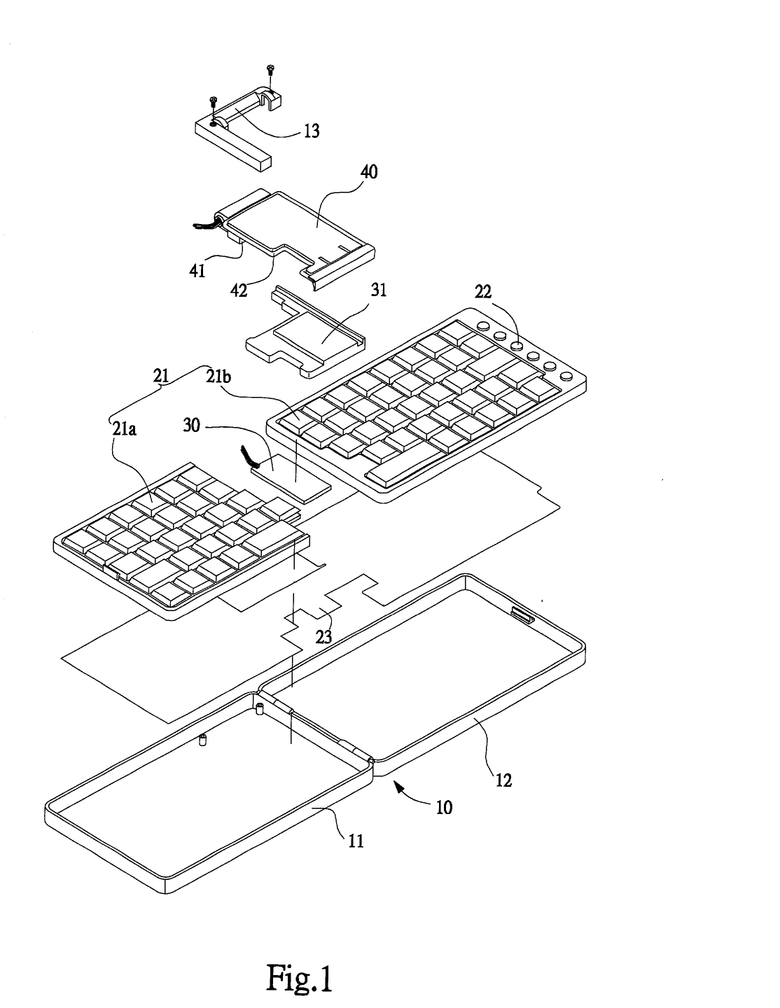

Referring to FIGS. 1 to 4, an external keyboard for PDAs in accordance with the present invention generally a housing 10 including first and second halves 11, 12 hinged together. Accordingly, the first and second halves 11, 12 can be readily folded together when the keyboard is not in use, or unfolded when the keyboard is used as an input device of a PDA device 50.

A flexible printed circuit board 23 is deployed within the housing 10. The flexible printed circuit board 23 is used as a portion of a keyswitch and which is known to the skill in the art. Accordingly, no detailed description is given hereinafter.

A keyboard assembly 21 is configured by a first keyboard subassembly 21a attached to the first half 11 of the housing 10, and a second keyboard subassembly 21b attached to the second half 12. The keyboard assembly 21 includes a plurality keyswitches (not labeled) jointly work with the flexible printed circuit board 23 to generate electrical signal. Again, this is known to the skill to the art and no detailed description is given hereinafter.

The keyboard assembly 21 further includes a plurality of functional keys 22 which are located together with the second keyboard subassembly 21b.

A printed circuit board 31 is firmly attached to the housing 10 and electrically connected to the flexible printed circuit board 23 for converting movements of the keyswitch into electrical signals which are readable by the PDA device 50.

A supporting bracket 40 is pivotally mounted within the first half 11 of the housing 10. Accordingly, the supporting bracket 40 can be completely flattened within the first half 11 of the housing 10 for storing, and the supporting bracket 40 can be fully extended and supports the PDA device 50 thereon. The supporting bracket 40 is provided with a connector 41 for electrically connecting with a connector of the PDA device 50. Accordingly, the PDA device 50 is completely connected with the keyboard assembly 21. The supporting bracket 40 further includes an anchoring foot 42 with which the supporting bracket 40 can be firmly positioned in an inclined position. As a result, the user can easily read the screen of the PDA device 50.

One of the advantages of the present invention is that the spacing between two adjacent keyswitches can be robustly widen such that the user can easily type them without any difficulty. This is because the keyboard assembly 21 is divided into the first and second keyboard subassemblies 21a, 21b and each has enough surface area for installing the keyswitches.

The other advantage is that when the keyboard 21 is folded, it has a compact dimension for carry and which is impossible for the conventional keyboard device.

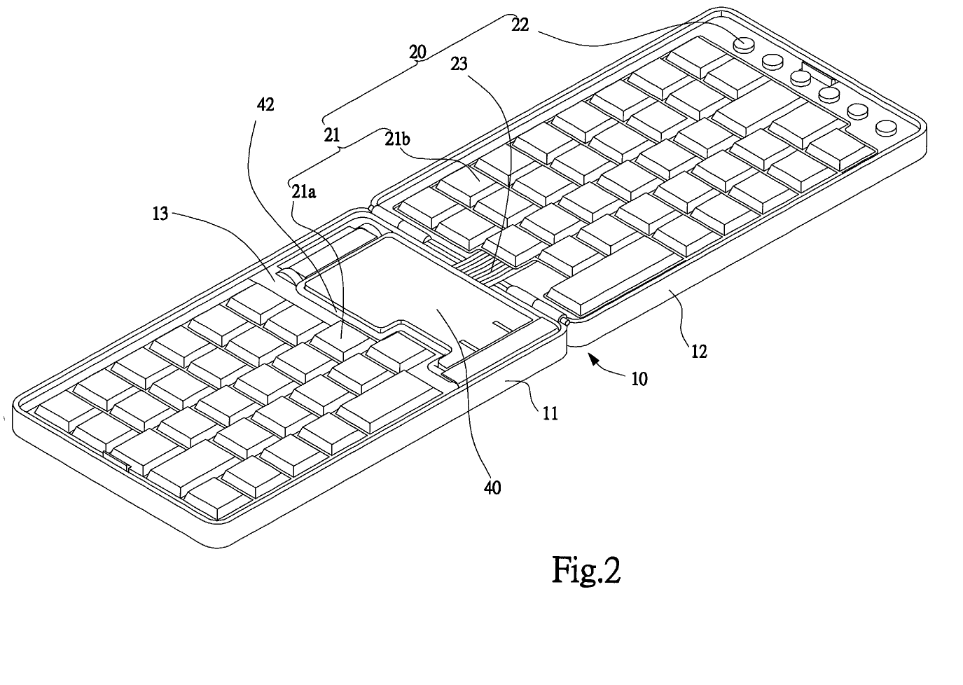

In use, as shown in FIG. 2, the first and second keyboard subassemblies 21a, 21b can be easily unfolded in which all keys are accessible and the supporting bracket 40 is also accessible for use.

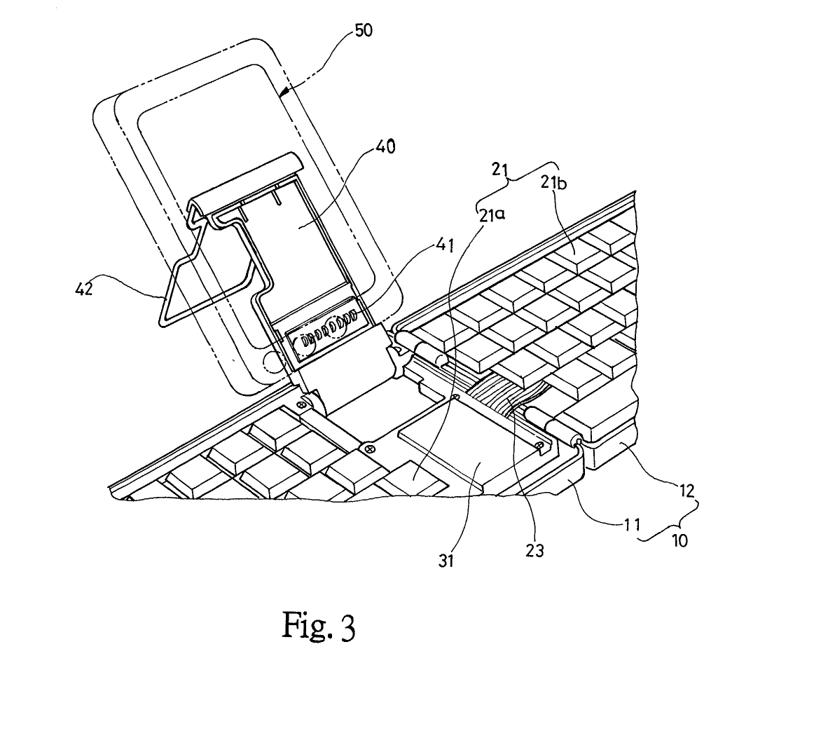

As shown in FIG. 3, the supporting bracket 40 can be readily lifted and then positioned in which the PDA device 50 (shown in dotted lines) can be firmly supported. In addition, when the anchoring foot 42 is extended, the supporting bracket 40 can be positioned in an inclined position such that the PDA device 50 is also supported in an inclined position. When the PDA device 50 is supported in the supporting bracket 40, it is electrically connected to the connector 41. As the PDA device 50 is suitably supported in the inclined position, the screen of the PDA device 50 can be readily read.

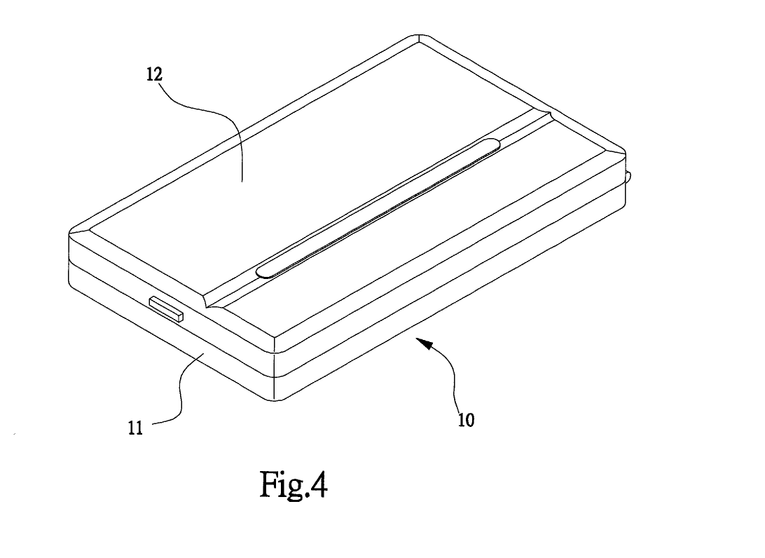

As shown in FIG. 4, after the usage, the first and second keyboard subassemblies 21a, 21b can be easily folded, thereby providing a compact size for carry.

It will be understood that the invention may be embodied in other specific forms without departing from the spirit or central characteristics thereof. The present example and embodiment, therefore, is to be considered in all respects as illustrative and not restrictive, and the invention is not to be limited to the details given herein.

1. An external keyboard for PDAs, comprising:
a housing including first and second halves hinged together;
a flexible printed circuit board received within said housing;
a first keyboard subassembly, each first subassembly including a plurality of keys jointly with said flexible printed circuit board to define first keyswitch subassembly;
a second keyboard subassembly, each second subassembly including a plurality of keys jointly with said flexible printed circuit board to define second keyswitch subassembly workable with said first keyswitch subassembly;
a printed circuit board electrically connected to said flexible printed circuit board for converting movement of said keyswitch into an electrical signal; and
a supporting bracket pivotally mounted within said housing, said supporting bracket including a connector adapted for connection with a connector of a PDA device, and electrically connected to said printed circuit board.

2. An external keyboard for PDAs as recited in claim 1, wherein said supporting bracket further includes an anchoring leg such that said supporting bracket can be firmly positioned in an inclined position.
